(19) United States
(12) Patent Application Publication
(10) Pub. No.: US 2003/0021287 A1
(43) Pub. Date: Jan. 30, 2003

(54) Communicating data between TDM and packet based networks

(75) Inventors: Charles Lee, Ashland, MA (US); Harsh Kapoor, Boxborough, MA (US)

Correspondence Address: HALE AND DORR, LLP, 60 STATE STREET, BOSTON, MA, 02109

(73) Assignee: Appian Communications, Inc., Acton, MA

(21) Appl. No.: 10/137,197

(22) Filed: May 2, 2002

Related U.S. Application Data
(60) Provisional application No. 60/288,912, filed on May 4, 2001.

(51) Int. Cl. H04B 7/212

(52) U.S. Cl. 370/442; 370/498

(57) ABSTRACT

A method and a system are provided for use in communicating data between a time division multiplexing (TDM) network and a packet based network. A clock signal is derived from data packets containing data originally transmitted over the TDM network. Outgoing TDM data is obtained using the data packets and the clock signal. The outgoing TDM data has timing characteristics of the data originally transmitted over the TDM network. Data extracted from the data packets may be collected in a FIFO and the clock signal may be derived in part from fill level information for the FIFO.

### CROSS-REFERENCE TO RELATED APPLICATIONS

This application claims the benefit of U.S. Provisional Application No. 60/288912, entitled “EMULATING TIME DIVISION MULTIPLEXING CONNECTIONS” filed on May 4, 2001, which is incorporated herein by reference in its entirety.

### BACKGROUND OF THE INVENTION

This application relates to communicating data between TDM and packet based networks.

A time division multiplexing (“TDM”) medium carries a signal that represents multiple constituent signals in defined time slots. For example, a T1 signal is a TDM signal that may represent up to 24 constituent voice signals. The T1 signal has a transmission rate of 1.54 Mbps, with each constituent voice signal having a rate of 64 kbps.

T1 relies on a specific kind of TDM known as synchronous TDM, according to which a frame is periodically generated and includes a constant number of time slots, wherein each time slot has a constant length. The time slots can be identified by position in the frame, e.g., time slot 1, time slot 2, and each constituent signal is assigned a reserved time slot.

A T1 frame has 24 time slots per frame, numbered 1-24, and has one leading bit for framing purposes. Each time slot can carry 8 bits, such that the frame length is 193 bits. The frame repetition rate is 8000 Hz, which results in the 1.54 Mbps transmission rate for a T1 signal.

In an application such as standard telephone calls, two T1 signals can carry signals representing 24 simultaneous calls between two endpoints such as an office building and a telephone company switching office. At each endpoint, for each call, the incoming (“listening”) portion of the call may be extracted from the incoming T1 signal and the outgoing (“speaking”) portion of the call may be inserted into the outgoing T1 signal. Since each call is assigned a reserved time slot in each direction, the call signals are delivered by the T1 signals with little or no latency.

A packet-switching medium operates as follows. A sequence of data is sent from one host to another over a network. The data sequence is segmented into one or more queued packets, each with a data load and with a header containing control information, and each packet is routed through the network. A common type of packet switching is datagram service, which offers little or no guarantees with respect to delivery. Packets that may belong together logically at a higher level are not associated with each other at the network level. A packet may arrive at the receiver before another packet sent earlier by the sender, may arrive in a damaged state (in which case it may be discarded), may be delayed arbitrarily (notwithstanding an expiration mechanism that may cause it to be discarded), may be duplicated, or may be lost.

A well known example of a packet-switching medium is the Internet. Various attempts have been made to send time-sensitive data such as telephone call voice data over the Internet in packets. Typical concerns include reliability issues that the packets reach their destination without being dropped and predictability issues that the packets reach their destination without excessive delay. For the real-time transporting of voice data over the Internet, reliability and predictability are important. It has been found that dropped packets can distort voice quality if there is a considerable delay in the retransmission of those packets, and that excessive delay in the delivery of the packets can introduce inconsistencies in voice quality.

### SUMMARY OF THE INVENTION

A method and a system are provided for use in emulating time division multiplexing connections across a packet switch network. In particular, a method of packet circuit emulation (“PACE”) is provided for use in communicating data between a time division multiplexing (TDM) network and a packet based network. A clock signal is derived from data packets containing data originally transmitted over the TDM network. Outgoing TDM data is obtained using the data packets and the clock signal. The outgoing TDM data has timing characteristics of the data originally transmitted over the TDM network. Data extracted from the data packets may be collected in a first-in first-out buffer memory (“FIFO”). The clock signal may be derived in part from fill level information for the FIFO.

Thus, an adaptive clock recovery mechanism is provided that is well suited for use with packet based networks. Adaptive heuristics are provided to reduce end to end latency. Jitter and wander are reduced, to approach or meet Bellcore requirements. Also provided are automatic recovery from protection switches and automatic adaptation to changes in the network such as increases in load. A capability of operation with or without a stratum clock is provided.

These and other features will be apparent upon review of the following detailed description, claims, and the accompanying figures.

### BRIEF DESCRIPTION OF THE DRAWINGS

FIGS. 1-7 are block diagrams of packet and TDM data processing systems.

### DETAILED DESCRIPTION

A method and a system are provided for use in emulating time division multiplexing connections across a packet switch network. In particular, a method of packet circuit emulation (“PACE”) is provided for emulating a time division multiplex (“TDM”) connection across a packet based network. The method and system may be provided in a node having a TDM connection and a packet network connection, such as an Optical Services Activation Platform (“OSAP”) node by Appian Communications, Inc., described in co-pending U.S. patent application Ser. No. 09/546,090, which is hereby incorporated by reference in its entirety.

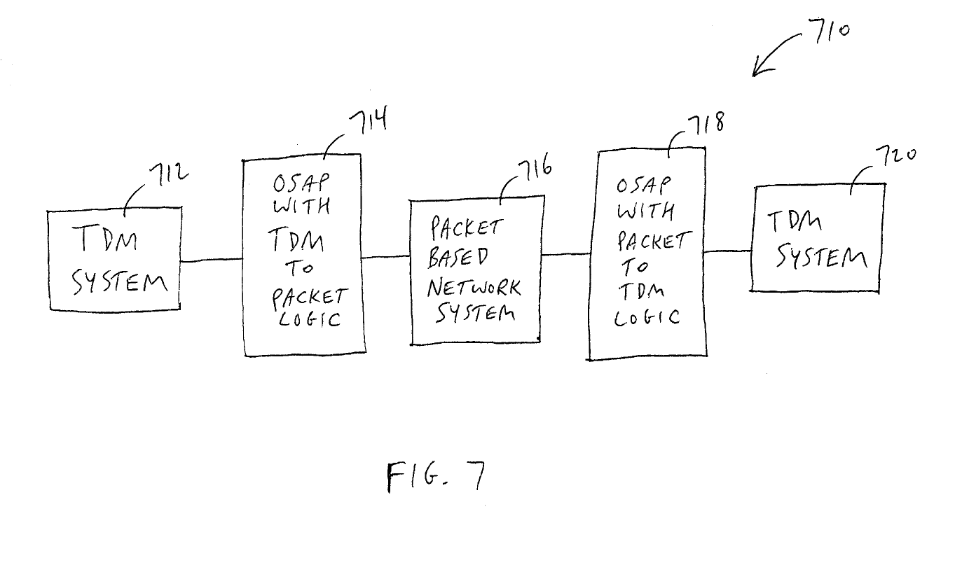

FIG. 7 illustrates an example system 710 in which a first OSAP 714 provides a connection between a TDM system 712 and a packet based network system 716, and a second OSAP 718 provides a connection between packet based network system 716 and a TDM system 720. In example system 710, to support data transfer from TDM system 712 to TDM system 720, PACE relies on TDM to packet logic in first OSAP 714 and packet to TDM logic in second OSAP 718.

In a particular embodiment of the emulation, at one end PACE maps a T1 data stream onto a constant packet stream and at the other end de-maps the packet stream onto another T1 data stream which PACE provides with at least some of the clocking characteristics of the original T1 stream. In a specific implementation, a physical user interface is provided for PACE that is a T1 interface having T1 compliant electrical and timing characteristics. (T1 is an example; other technologies may be used instead of, or in addition to, T1.)

As described below, to emulate TDM data handling, PACE addresses a jitter problem inherent in packet networks and recovers the source clock. Variations in the phase of a signal are known as jitter or wander. Rapid variations are known as jitter. Slow variations are known as wander. Variations are generally considered slow if they occur less than 10 times per second (10 Hz). With respect to digital signals in particular, “jitter” refers to periodic or stochastic deviations of the significant instants of a digital signal from its ideal, equidistant values. Otherwise stated, jitter is produced when the transitions of a digital signal occur either too early or too late when compared to a perfect squarewave.

TDM data has relatively stringent requirements with respect to jitter and wander, compared to packet-based networks. Packet based networks tend to exhibit more jitter than TDM networks due to packetization and queuing; TDM networks such as SONET and T1 are less susceptible to jitter as a result of carrying data in time slots that are nearly evenly spaced in time. The act of transferring TDM data to a packet introduces jitter because packet transmission causes a block of data to be sent all at once instead of in a stream of evenly spaced portions. Queuing introduces jitter by introducing variable delays in the transmission of TDM packets. TDM packets may have to wait to be sent after other, large packets are sent. Congestion and variations in data load can cause changes in delay, increasing the jitter.

In a TDM network, synchronization is affected by a source clock that produces an electrical timing signal to be distributed. The source clock is a highly stable clock, generally referred to as a stratum 1 source. A stratum 1 source is a highly reliable timing source, e.g., one that has a free running inaccuracy on the order of one-part in 10¹¹. A TDM network provides traceability of timing back to a stratum 1 source to help ensure timing stability.

In particular, a process of helping to ensure that all TDM nodes are timed from the same clock source is referred to as synchronization distribution. Regardless of the transport network architecture, timing distribution in rings and fully-connected meshes, for example, are considered as an overlay of linear paths to each mode from a master clock, i.e., as a tree structure.

Since it is impracticable for a large TDM network to rely on a single master clock, many master clock sources are used, each with sufficiently high accuracy that any traffic degradation is negligible. These master clocks serve as the stratum 1 sources.

Each location with a stratum 1 clock source has other locations subtended from it, with respect to a timing distribution. Clock quality is defined by several parameters, such as filtering capability, transient suppression, and holdover accuracy during any loss of stratum 1 connection. These subtended, or ‘slave,’ clocks form a quality hierarchy and are described as stratum 2, 3E, and 3. Under normal circumstances (i.e., no network failures), every slave clock in the network is synchronized, or traceable, to a stratum 1 clock. Accordingly, each slave clock has at least two potential reference inputs, typically prioritized as primary and secondary.

In general, PACE includes two main functions: a TDM to packet conversion function and a packet to TDM conversion function.

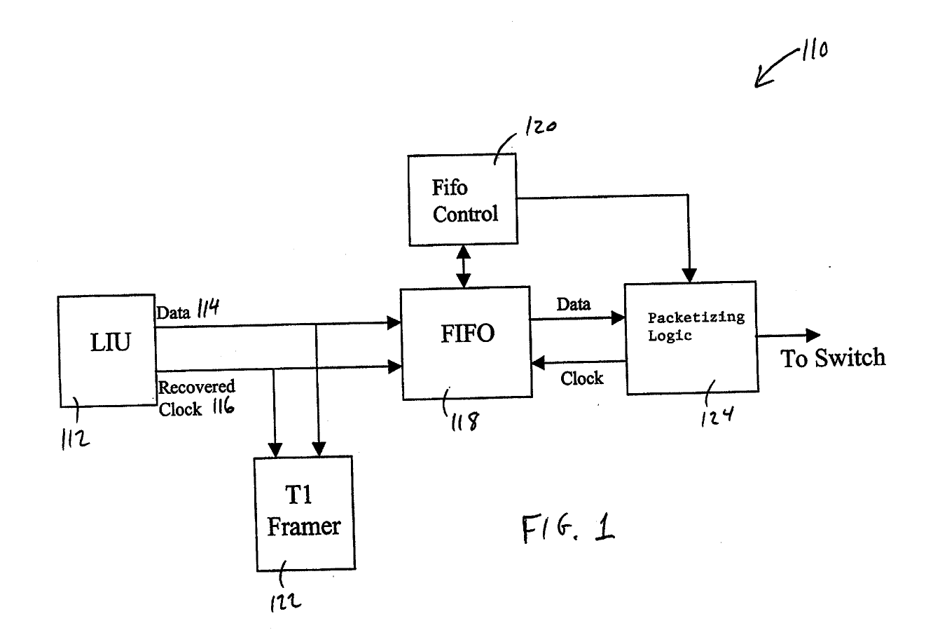

FIG. 1 shows an example data flow in TDM to packet conversion logic 110, which has the following characteristics. T1 data 114 is collected (“recovered”) from a Line Interface Unit (“LIU”) 112 in conjunction with a recovered clock 116 associated with the recovered T1 data. (In an example implementation, the LIU may provide optical to electrical conversion, framing detection and synchronization, and the ability to extract timing from the incoming signal, and use it as a receive clock for incoming data. The LIU may detect alarms, frame errors, parity errors, and far end errors, including framing errors.) T1 framer logic 122 monitors the T1 signal for error conditions.

Data is accumulated in a FIFO 118 at the recovered clock rate as directed by FIFO control logic 120 until enough data has been accumulated to fill a packet. (In one or more embodiments, one or more FIFOs such as FIFO 118 may be based on static random access memory, or SRAM.) In a specific implementation, each packet has a fixed size payload, i.e., each packet has the same number of bits. (The fixed payload size is an example; a payload size that is not fixed may be used instead of, or in addition to, the fixed payload size.) Packetizing logic 124 handles peer signaling (e.g., sequence numbering and trail tracing) by providing a PACE header as described below. A packet is thus created having the data as the payload of the packet and a PACE header; the packet is sent to the packet-based network via a switch.

In at least one type of embodiment, because the payload size is fixed, a direct relationship is established between the packet rate and the clock rate, thereby aiding subsequent recovery of the T1 clock and determination of network jitter, as described below.

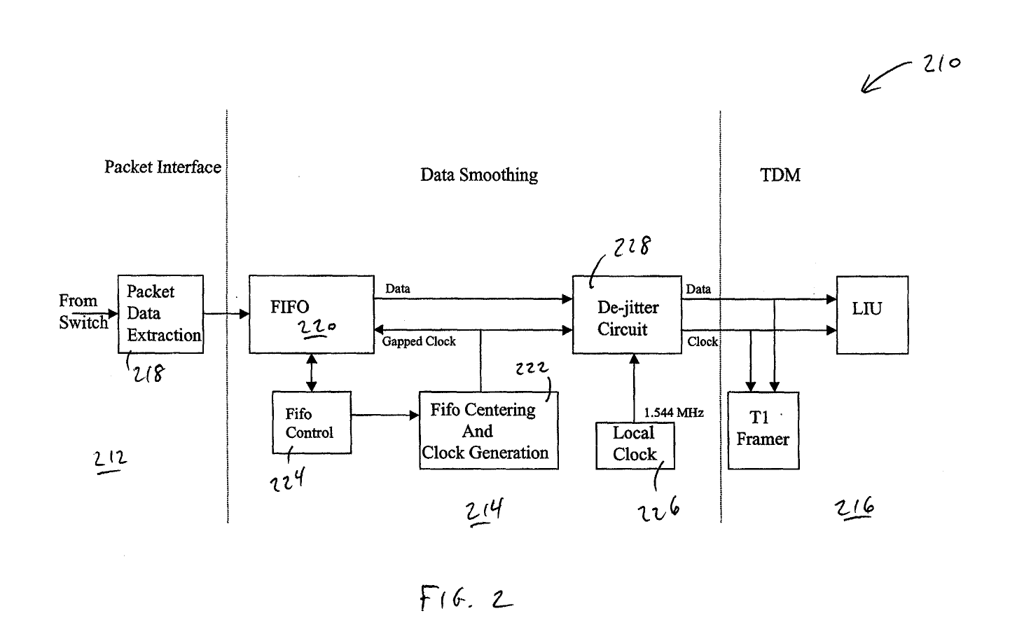

As shown in FIG. 2, example packet to TDM conversion logic 210 includes packet interface logic 212, data smoothing logic 214, and TDM logic 216. The packet interface logic has packet data extraction logic 218 that extracts the payload data from the packet and sends it to a FIFO buffer 220. Packet interface logic 212 also handles peer signaling and monitoring via the received PACE header, which includes information for round trip delay processing, sequence numbers, trail trace messages, status monitoring, and redundant data recovery.

As described below, round trip delay measurements are made by using RTsnd and RTrcv bits in a PACE header.

A trail trace message includes a 16 byte string and is assembled by packet interface logic 212 from the received packets. Packet interface logic 212 also inserts a message into a trail trace message field.

Data smoothing logic 214 includes two stages. The first stage helps to remove jitter caused by the packet network. The second stage helps to remove jitter inherent in the implementation logic and data path and also tracks the wander associated to the source. The second stage provides standards compliant timing at its output.

The first stage of the data smoothing logic includes clock generation and FIFO centering logic 222. The T1 source clock rate is recovered from the rate of the data entering the FIFO. The FIFO fill level (i.e., the difference between the producer “write” and consumer “read” pointer points of the FIFO) and FIFO control logic 224 are used to track the clock rate. The FIFO fill level remains stable if the output clock rate from FIFO 220 is the same as the incoming data rate at the input of FIFO 220. To track the incoming data rate, the output clock is adjusted to maintain the FIFO fill level at the FIFO center. When the FIFO fill level exceeds the FIFO center, the output clock rate is increased until the FIFO fill level stabilizes at the FIFO center. If the FIFO level falls below the FIFO center, the output clock rate is decreased until the FIFO fill level stabilizes at the FIFO center. Accordingly, especially over the long term, the output clock rate tracks the clock rate of the source.

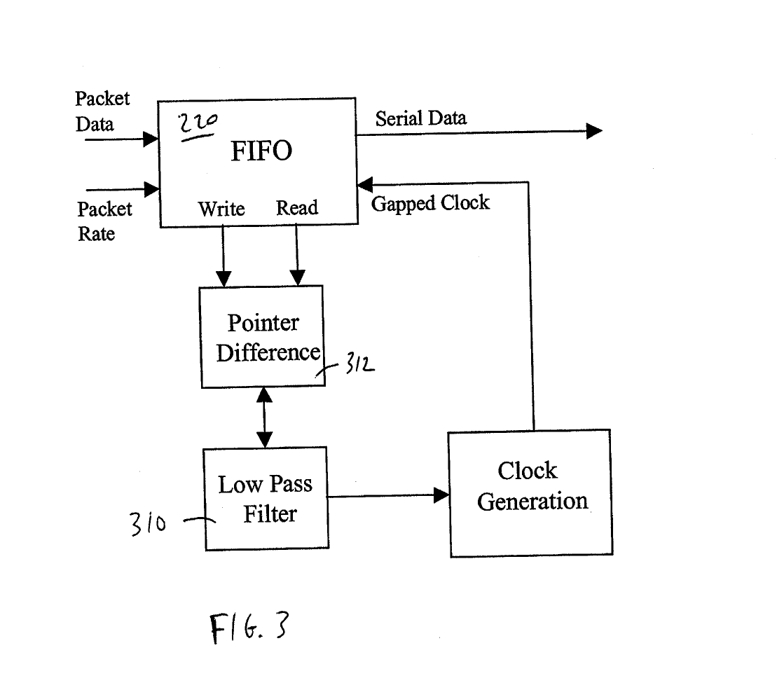

As shown in FIG. 3, the FIFO fill level may be filtered before it is used to control the output clock, to help prevent sudden changes in the data rate from affecting the output clock. A low pass digital filter 310 used for this purpose filters differences in write and read pointers detected by pointer difference logic 312. The filtered FIFO level tracks the clock rate of the data source and its associated wander.

The filtered FIFO fill level may be used as follows, in an example of filtering. One way to filter the fill level is to first calculate the derivative of the fill level, which indicates the change of the fill level over a time period. Jitter caused by the packet based network and packetization generally results in relatively large changes to the derivative of the fill level. Differences between the data rate and the output clock generally results in relatively small changes to the derivative of the fill level. A low pass filter attenuates the large changes in the derivative of the fill level, which produces a value that largely or mostly reflects the difference between data rate and output clock. Some of the packet related jitter has low frequency components that are not filtered out by the low pass filter and cause some wander in the filtered fill level. If such frequencies are under 10 hertz, the wander is acceptable at the TDM interface.

In at least one embodiment, when the filtered fill level is positive, the output clock needs to be increased; if the filtered fill level is negative, the output clock needs to be decreased; if the filtered fill level is zero, the output clock does not need to be adjusted. The amount of change that is needed on the output clock depends on the filtered fill level value and the sampling rate.

In a specific implementation, the output of the FIFO is clocked with a gapped clock (i.e., a clock stream at a nominal frequency which may be missing clock pulses at arbitrary intervals for arbitrary lengths of time). The nominal frequency of the gapped clock is the recovered clock rate. The rate of change in the FIFO output clock is limited to help avoid inducing jitter into the second stage.

Internal timing, which is described in more detail below, is achieved by using a local clock 226 (FIG. 2) as the FIFO output clock.

FIFO centering heuristics are a set of methods used to determine the FIFO center level at various phases, including an acquire phase and a monitor phase.

The acquire phase establishes a valid incoming signal, determines the FIFO center, and stabilizes the output data rate. The incoming packet stream is verified by monitoring sequence numbers in the PACE header. A packet stream is valid when there is no data loss. PACE calculates the FIFO center based on the measured round trip delays and minimum and maximum (“min-max”) jitter levels. The round trip delay is measured by using the round trip send and round trip receive bits RTsnd, RTrcv in the PACE header. (A timer that may be associated with the packetizing logic is started at the time the RTsnd bit is set, and is sent to the packet network by the packetizing logic. When a set RTrcv bit is received by packet data extraction logic 218, the timer is stopped and its value is stored as the current round trip delay measurement.) The min-max jitter level is determined by recording the minimum and maximum FIFO level during a measurement period. The FIFO center is calculated presuming that the measured parameters represent a best case and that the FIFO center should be large enough to absorb worst case jitter.

Once the incoming packet stream is validated and a FIFO center has been chosen, the output data rate is stabilized. This is done by configuring the FIFO center, clocking data out, and monitoring the filtered FIFO level. When the detected changes in the filtered FIFO level are bounded within the locked window, the output data rate is considered stable. Entry to the monitor phase occurs when the output data is stabilized.

With respect to calculating the FIFO center, in at least one embodiment, multiple round trip delay measurements are made and the highest and lowest values are recorded. The highest value is called the Max Round Trip Delay and the lowest value is called the Min Round Trip Delay.

The Max Round Trip Delay is used to calculate initial FIFO center. The initial FIFO center is equal to the Max Round Trip Delay divided by 2 and divided by 648 nanoseconds per bit. This is the parameter that is used when emulating T1 data streams. For example, if the Max Round Trip Delay is 10 milliseconds, the initial FIFO center is equal to 7716 bits.

10 ms/(2*648 ns per bit)=7716 bits

The FIFO is filled with data to the FIFO center and data starts being clocked out of the FIFO. The lowest absolute fill level is monitored. If the lowest absolute fill level is less than the FIFO center divided by 2, the FIFO center is increased so that the difference between the FIFO center and the lowest absolute fill level is less than or equal to the original FIFO center divided by 2. For example, if the initial FIFO center is 7716 bits and the lowest absolute fill level detected is 3800 bits, the FIFO center should be increased by 116 bits (i.e. ((7716/2)-3800)*2) to 7832 bits. The lowest absolute fill level is monitored again and further adjustments can be made. These steps are repeated until adjustments are not needed or for 4 times the Max Round Trip Delay (the larger the potential jitter, the longer it is desirable to monitor its jitter).

This process establishes a FIFO center that is suitably not too large and not too small for the packet based network that is providing the transport packets. The FIFO center need not be manually configured, and is automatically determined at the beginning of operation and can be monitored while operational. Changes in the packet based network are automatically adjusted by either recalculating the FIFO center or slowly adjusting the FIFO center.

In the monitor phase, the PACE traffic is monitored to determine changes in the network and to adjust to them. The FIFO center may be adjusted due to changes or variations in the packet-based network. The minimum and maximum FIFO levels and round trip delays are used to adjust the FIFO center to reduce the end to end latency and also to provide sufficient buffering to absorb changes in the network.

PACE (e.g., at packet interface 212) also detects failures to determine the need to acquire the packet stream again. The failures include sequence number error, loss of lock (i.e., incoming clock rate being out of range), FIFO overrun, FIFO underrun, and connectivity error (i.e., an incorrect trail trace).

With reference to FIG. 2, a second stage of the data smoothing logic includes a de-jitter circuit 228 for attenuation. The data smoothing logic can operate with very fine granularity in its clock control. De-jitter circuit 228 removes clock jitter (e.g., as required by Bellcore and ANSI) and tracks the wander in the clock.

Based on the data and clock results of the data smoothing logic, TDM logic 216 outputs TDM data to an LIU.

TDM logic provides legacy TDM interfaces and protocols including T1 framing and monitoring, T1 electrical interfaces, and T1 timing.

A specific implementation of a PACE packet format, for Ethernet, is shown below.

| Destination | Source | | | | |
|---|---|---|---|---|---|
| Address | Address | Type Field | MPLS Label | Payload | FCS |
| 6 Bytes | 6 Bytes | 2 Bytes | 4 Bytes | 50 bytes | 4 Bytes |

The type field may contain 0×8847.

With respect to, e.g., the destination address, the SerDes header designates a port number and priority.

A specific implementation of a PACE payload format is shown below.

| PACE Header | Redundant Data | Data |
|---|---|---|
| 14 bits | 193 bits | 193 bits |

The PACE header contains PACE control and status bits. The redundant data includes data from a previous packet. The data portion includes new data.

A specific implementation of the PACE header is shown below.

| Sequence | | Trail Trace | | | |
|---|---|---|---|---|---|
| Number | Status | Message | RTsnd | RTrec | Reserved |
| 7 bits | 1 bit | 2 bits | 1 bit | 1 bit | 2 bit |

The sequence number portion is used to maintain the sequential nature of the data. The status portion indicates far end status. The far end status pertains to whether or not error conditions (such as incorrect sequence number, underflow, or overflow) have been detected at the far end. When the status portion is 0, no error conditions have been detected. When the status portion is 1, one or more error conditions have been detected. The trail trace message includes an identifier or source used to verify end to end connectivity. The RTsnd portion includes the Round Trip send bit, and the RTrec portion includes the Round Trip receive bit.

In a specific implementation, line and diagnostic loopback capability is supported. The loopbacks are available through the line and system side (for packetizing and de-packetizing blocks). WAN type diagnostic features are supported.

PACE supports two timing modes: external and internal. Internal timing may be provided by a clock source generated in the OSAP (such as local clock 226) or a clock source that is stratum traceable.

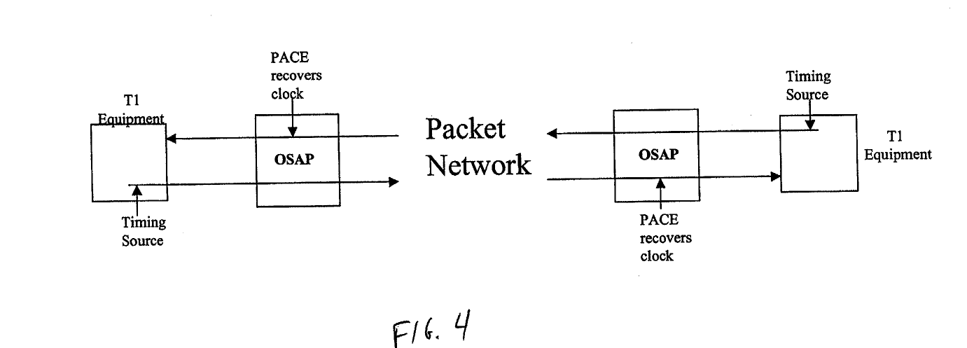

The external timing mode is used when timing is originated at the T1 termination points external to the OSAP. FIG. 4 illustrates an example of this timing configuration. FIG. 4 shows the timing being originated at both ends. PACE attempts to recover the clock at both ends.

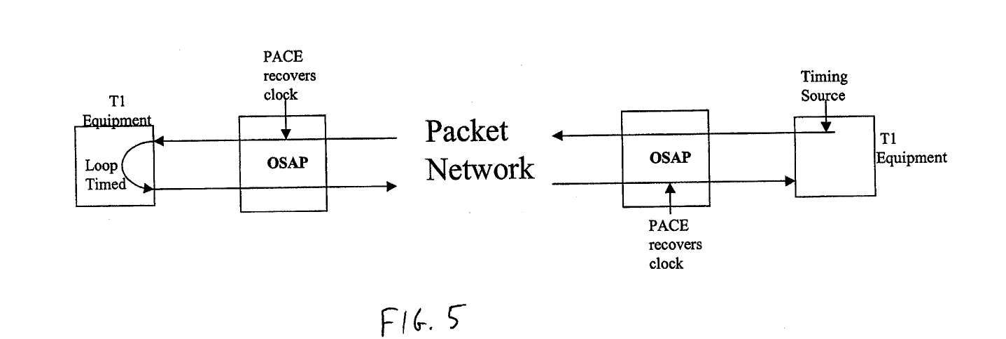

In another possible configuration, illustrated in FIG. 5, the timing is originated at one end and the other end is loop timed. PACE attempts to recover the clock at both ends.

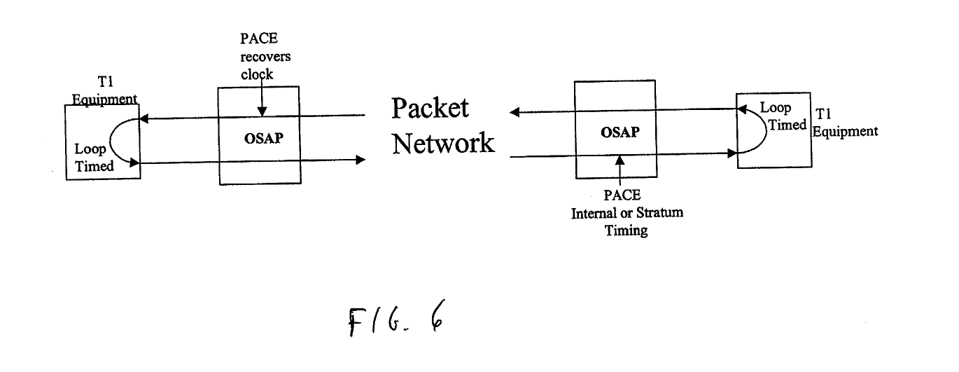

Internal timing is a mode that is used when the external equipment at both ends is incapable of sourcing timing. In this case, PACE originates timing at one end and recovers the clock at the other end. FIG. 6 shows an internal timing configuration where the T1 equipment at both ends is loop timed. In at least some cases, if both OSAPs are internally timed, it is useful or preferable if their clocks are stratum traceable.

The systems and methods described herein may be implemented in hardware or software, or a combination of both. In at least some cases, it is advantageous if the technique is implemented in computer programs executing on one or more programmable computers, such as an embedded system or other computer running or able to run V×Works (or Microsoft Windows 95, 98, 2000, Millennium Edition, NT; Unix; Linux; or MacOS); that each include a processor such as a Motorola PowerPC 8260 (or an Intel Pentium 4) possibly together with one or more FPGAs (field programmable gate arrays, e.g., by Xilinx, Inc.), a storage medium readable by the processor (including volatile and non-volatile memory and/or storage elements), possibly with at least one input device (e.g., a keyboard), and at least one output device. Program code is applied to data entered (e.g., using the input device) to perform the method described above and to generate output information. The output information is applied to one or more output devices (e.g., a display screen of the computer).

In at least some cases, it is advantageous if each program is implemented in a high level procedural or object-oriented programming language such as C++, Java, or Perl to communicate with a computer system. However, the programs can be implemented in assembly or machine language, if desired. In any case, the language may be a compiled or interpreted language.

In at least some cases, it is advantageous if each such computer program is stored on a storage medium or device, such as ROM or magnetic diskette, that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Other embodiments are within the scope of the invention. For example, the output clock may itself be filtered to help prevent sudden changes from adversely affecting the output clock. A round trip delay measurement may be enhanced by adding adjustment values in the PACE header, e.g., in additional fields. Adjustments may be made to the initial FIFO center calculation to tailor or optimize the calculation for specific networks. If it is known that the packet based network has certain characteristics (e.g., high latency but low jitter), the knowledge may be used to calculate a highly useful FIFO center.

Having described the invention and a preferred embodiment thereof, what we claim as new and secured by Letters Patent is:

1. A method for use in communicating data between a time division multiplexing (TDM) network and a packet based network, comprising:
deriving a clock signal from data packets containing data originally transmitted over the TDM network; and
obtaining outgoing TDM data using the data packets and the clock signal, the outgoing TDM data having timing characteristics of the data originally transmitted over the TDM network.

2. The method of claim 1, further comprising
removing at least some jitter from the derived clock signal.

3. The method of claim 2, wherein the source of the jitter includes the packet based network.

4. The method of claim 2, wherein the source of the jitter includes TDM data derivation logic.

5. The method of claim 1, further comprising
extracting data from the data packets; and
collecting the extracted data in a FIFO.

6. The method of claim 5, further comprising
determining a rate at which data is collected in the FIFO; and
basing the derivation of the clock signal on the collection rate.

7. The method of claim 5, further comprising
determining whether the fill level of the FIFO is stable; and
basing the derivation of the clock signal on the determination.

8. The method of claim 5, further comprising
determining that the fill level of the FIFO is above a threshold; and
increasing the clock signal rate based on the determination.

9. The method of claim 5, further comprising
determining that the fill level of the FIFO is below a threshold; and
decreasing the clock signal rate based on the determination.

10. The method of claim 5, further comprising
applying a low pass filter to fill level information from the FIFO; and basing the derivation of the clock signal on the filtered fill level information.

11. The method of claim 1, further comprising
transmitting data via a T1 data stream.

12. The method of claim 1, further comprising
transmitting data via a data stream based on a source clock.

13. The method of claim 12, wherein the source clock includes a stratum 1 clock.

14. The method of claim 1, further comprising
transmitting data based on synchronization distribution.

15. The method of claim 1, wherein at least one of the data packets has a fixed size payload.

16. The method of claim 1, further comprising
transmitting a data packet after accumulating an amount of original TDM data sufficient to fill the data packet.

17. The method of claim 1, further comprising
extracting data from the data packets; and
collecting the extracted data in an SRAM buffer.

18. The method of claim 1, further comprising
monitoring a T1 data stream for error conditions.

19. The method of claim 1, further comprising
transmitting a header with the data packets for peer signaling.

20. The method of claim 1, further comprising
establishing a direct relationship between a transmission rate of data packet transmission and a clock rate for the TDM data.

21. The method of claim 1, further comprising
transmitting a header with the data packets, the header including round trip delay processing information.

22. The method of claim 1, further comprising
transmitting a header with the data packets, the header including sequence numbers.

23. The method of claim 1, further comprising
transmitting a header with the data packets, the header including trail trace messages.

24. The method of claim 1, further comprising
transmitting a header with the data packets, the header including status monitoring information.

25. The method of claim 1, further comprising
transmitting a header with the data packets, the header including redundant data recovery information.

26. A system for use in communicating data between a time division multiplexing (TDM) network and a packet based network, comprising:
clock signal output logic receiving data packets containing data originally transmitted over the TDM network, and producing a clock signal based on the data packets; and
TDM data output logic receiving the data packets and producing outgoing TDM data based on the data packets and the clock signal, the outgoing TDM data having timing characteristics of the data originally transmitted over the TDM network.

27. The system of claim 26, wherein the clock signal produced by the clock signal output logic has reduced jitter.

28. The system of claim 26, wherein the source of the jitter includes the packet based network.

29. The system of claim 26, wherein the source of the jitter includes TDM data derivation logic.

30. The system of claim 26, further comprising
data extraction logic receiving data packets and producing data; and
a FIFO collecting the produced data.

31. A method for use in communicating data between a time division multiplexing (TDM) network and a packet based network, comprising:
producing data packets containing data originally transmitted over the TDM network; and
providing the data packets with control data allowing outgoing TDM data to be obtained using the data packets, the outgoing TDM data having timing characteristics of the data originally transmitted over the TDM network.

32. The method of claim 31, further comprising
transmitting data via a T1 data stream.

33. The method of claim 31, further comprising
transmitting data via a data stream based on a source clock.

34. The method of claim 33, wherein the source clock includes a stratum 1 clock.

35. The method of claim 31, further comprising
transmitting data based on synchronization distribution.

36. The method of claim 31, wherein at least one of the data packets has a fixed size payload.

37. The method of claim 31, further comprising
transmitting a data packet after accumulating an amount of original TDM data sufficient to fill the data packet.

38. The method of claim 31, further comprising
monitoring a T1 data stream for error conditions.

39. The method of claim 31, further comprising
transmitting a header with the data packets for peer signaling.

40. The method of claim 31, further comprising
establishing a direct relationship between a transmission rate of data packet transmission and a clock rate for the TDM data.

41. The method of claim 31, further comprising
transmitting a header with the data packets, the header including round trip delay processing information.

42. The method of claim 31, further comprising
transmitting a header with the data packets, the header including sequence numbers.

43. The method of claim 31, further comprising
transmitting a header with the data packets, the header including trail trace messages.

44. The method of claim 31, further comprising
transmitting a header with the data packets, the header including status monitoring information.

45. The method of claim 31, further comprising
transmitting a header with the data packets, the header including redundant data recovery information.

46. A system for use in communicating data between a time division multiplexing (TDM) network and a packet based network, comprising:
packetizing logic producing data packets containing data originally transmitted over the TDM network; and
control logic providing the data packets with control data allowing outgoing TDM data to be obtained using the data packets, the outgoing TDM data having timing characteristics of the data originally transmitted over the TDM network.

47. The system of claim 46, further comprising
logic transmitting data based on synchronization distribution.

48. The system of claim 46, wherein at least one of the data packets has a fixed size payload.

49. The system of claim 46, further comprising
logic transmitting a data packet after accumulating an amount of original TDM data sufficient to fill the data packet.

50. The system of claim 46, further comprising
logic monitoring a T1 data stream for error conditions.

51. The system of claim 46, further comprising
logic transmitting a header with the data packets for peer signaling.

52. The method of claim 46, further comprising
logic transmitting a header with the data packets, the header including round trip delay processing information.

53. Apparatus for use in communicating data between a time division multiplexing (TDM) network and a packet based network, comprising:
means for deriving a clock signal from data packets containing data originally transmitted over the TDM network; and
means for obtaining outgoing TDM data using the data packets and the clock signal, the outgoing TDM data having timing characteristics of the data originally transmitted over the TDM network.

53. Apparatus for use in communicating data between a time division multiplexing (TDM) network and a packet based network, comprising:
means for producing data packets containing data originally transmitted over the TDM network; and
means for providing the data packets with control data allowing outgoing TDM data to be obtained using the data packets, the outgoing TDM data having timing characteristics of the data originally transmitted over the TDM network.
